(19) United States
(12) Patent Application Publication
(10) Pub. No.: US 2005/0038890 A1
(43) Pub. Date: Feb. 17, 2005

(54) Load distribution method and client-server system

(75) Inventors: Mineyoshi Masuda, Yokohama (JP); Toshiaki Tarui, Sagamihara (JP); Tatsuo Higuchi, Fuchu (JP)

Correspondence Address: Stanley P. Fisher;Reed Smith LLP, Suite 1400, 3110 Fairview Park Drive, Falls Church, VA, 22042-4503, US

(73) Assignee: Hitachi., Ltd.

(21) Appl. No.: 10/782,971

(22) Filed: Feb. 23, 2004

(30) Foreign Application Priority Data
Aug. 11, 2003 (JP) 2003-291286

(51) Int. Cl. G06F 15/16; G06F 15/173

(52) U.S. Cl. 709/224; 709/217; 709/219; 709/223

(57) ABSTRACT

A load distribution method is adopted by a client-server system comprising a plurality of clients 100 and a server cluster 1100, which includes a plurality of servers 800 each used for processing requests made by the clients 100 and allows the number of the servers 800 to be changed dynamically. Each of the clients 100 detects the number of servers 800 composing the server cluster 1100, sets an allocation of requests transmissible out to a newly added server 900 at a value small in comparison with that set for each of the other servers 800 right after detecting an increase in server count and then transmits out requests to the servers on the basis of the set allocation. It is thus possible to provide the clients 100 and the server-cluster system 1100 with the load distribution method suitable for a cluster reconfiguration technology for changing the number of servers composing the server-cluster system 1100 in accordance with an increase and a decrease in demand for a service.

### FIELD OF THE INVENTION

The present invention relates to a load distribution method provided as a method for distributing loads of rendering services requested by clients among servers composing a server-cluster system and as a method suitable for a cluster reconfiguration technology for changing the number of servers composing the server-cluster system in accordance with an increase and a decrease in demand for services in a client-server system utilizing, among others, the server-cluster system serving as a system for processing services demanded by users of services and for constructing services such as electronic business transactions using the Internet, and relates to the client-server system adopting the load distribution method.

The present invention is particularly useful when applied to distribution of loads between upstream and downstream servers in a hierarchical web system for processing loads in accordance with a hierarchical structure such as a sequence of servers comprising a web server at the start of the sequence, a database server at the end of the sequence and an application server between the web and database servers. In addition, the present invention is also useful when applied to distribution of loads among a plurality of directory servers employed in a storage system for distributing directory information of files stored in a plurality of storage apparatus among the directory servers.

### BACKGROUND OF THE INVENTION

A server-cluster system comprising a plurality of servers is used in a computer system for rendering a variety of services including electronic business transactions on the Internet. A network is used for connecting the servers composing the server-cluster system to each other so that the server-cluster system appears to users as a single-server system. In a computer system using a server-cluster system, loads of rendering services requested by clients are generally distributed among servers composing the server-cluster system. To put it concretely, distribution of requests made by clients is determined to apportion the requests to the servers composing the server-cluster system in accordance with the processing powers of the servers. By the request, a request for processing of a service is implied.

A load distribution algorithm adopted in the distribution of loads is a procedure for determining how many requests are to be apportioned to each of the servers and which server is to be designated as a server for handling certain requests. The load distribution algorithm affects the performance of the server-cluster system. If an inappropriate load distribution algorithm is adopted, requests made by the clients are not distributed equally among the servers so that an imbalance of loads results among the servers. The processing time of a server bearing a heavy load to process requests increases substantially in comparison with a server bearing a light load so that the processing of a request cannot be completed in time. In the case of a service on the Internet, for example, a late completion of request processing appears to the user of services as a slow response.

As a representative of the load distribution algorithm serving as an element of importance to the server-cluster system, a round-robin method is known. The round-robin method is a method of rearranging a priority sequence so that a request signal is selected among a plurality of request signals in accordance with a priority sequence determined in advance and the signals are selected equally. By adopting the round-robin method, requests are output to servers each serving as a load distribution target in turn. For details, refer to a reference such as Japanese Patent Laid-open No. 2000-231496.

In addition, a distribution system applying the round-robin method includes a weighted round-robin method. The weighted round-robin method is a method by which the priority sequence of the round-robin method is rearranged in accordance with predetermined weights. In accordance with the weighted round-robin method, the performance of every server is computed on the basis of the operating frequency of a processor employed in the server and the size of a memory employed in the server, and is used as the weight of the server. Then, for every server, a number of requests proportional to the weight of the server is apportioned to the server. For details, refer to a reference such as U.S. Pat. No. 6,343,155.

In addition, in recent years, there has been proposed a technology referred to as a cluster reconfiguration technology for dynamically reconfiguring a server-cluster system. The cluster reconfiguration technology is a technology adopted by a load balancer to apportion service requests made by clients at a run time to servers operating in a server cluster as well as a technology for changing the configuration of a server cluster or changing the number of servers composing the cluster in accordance with an access load. The cluster reconfiguration technology is particularly useful for a system in which the number of service users changes substantially. An example of the system in which the number of service users changes substantially is a system for providing services through the Internet. For details, refer to a reference such as Japanese Patent Laid-open No. 2002-163241.

A system obtained by applying a server-cluster system to a NAS (Network Attached Storage) is also known as a system for managing a table of combinations each associating a file with a storage location of the file, wherein a hash function is applied to an identifier assigned to every file so as to make the capacity of the NAS easy to increase and decrease. For details, refer to a reference such as US Patent Laid-open No. 2003/0,220,985.

A load balancer put in the market by Foundry Network Corporation is called ServerIron, which has a slow start mechanism as disclosed in Foundry ServerIron Switch Installation and Configuration Guide [online], searched on Jan. 13, 2004 at a URL of <hppt://www1.oji.hitachi.co.jp/PCSERVER/ha8000_ie/material/ie_m/0207/lf/lf_guide6.pdf>, sections 12-62 to 12-69. The slow start mechanism is a function executed by the load balancer to impose an upper limit on the number of requests that can be assigned to a newly added server during a predetermined period of time following the addition of the new server in an operation to add the server to serve as a new target of load distribution. Assume for example that a ‘smallest connection count’ algorithm is adopted as the load-distribution algorithm. With such an algorithm adopted, in a normal case, requests are continuously transmitted out to an added server, which has a number of connections right after the addition equal to zero, so that responses to the requests processed by the added server deteriorate substantially. If the slow start mechanism is used, however, an upper limit is imposed on the number of requests transmissible out to the added server during a predetermined period of time following the addition of the new server. Thus, the responses to the requests processed by the added server can be prevented from deteriorating. A person in charge of system management can set parameters such as the upper limit and the length of the predetermined period of time during which the upper limit imposed on the number of requests transmissible out to the added server is effective.

If the cluster reconfiguration technology described above is adopted in conjunction with an improper load distribution algorithm, nevertheless, an imbalance of loads may result among servers composing a server-cluster system when a new server is added to the server-cluster system. This imbalance of loads among servers is caused by a difference in request-processing power between the server newly added to the server-cluster system by adoption of the cluster reconfiguration technology and existing servers already operating in the server-cluster system.

Such a difference in request-processing power between servers is due to, among other causes, a cache described as follows.

As an example, the following description explains a server-cluster system comprising a plurality of cache servers. A cache server is placed on the upstream side of a web server, that is, between the web server and the user of services and can serve as a substitute for the web server. As a substitute for the web server, the cache server transmits a web content to the user of services in response to a request made by the user of services as a request for transmission of a web content. If the requested web content has been cached in the cache server, that is, if the requested web content has been stored in a cache employed in the cache server, the cache server is capable of delivering the cached web content to the user of services immediately without the need to acquire the web content from the web server. Thus, the time it takes to respond to the request made by the user of services is short. If the requested web content has not been cached in the cache server, on the other hand, the cache server must first obtain the requested web content from the web server before the cache server is capable of delivering the web content to the user of services. Thus, the time it takes to respond to the request made by the user of services is long. That is to say, the time it takes to respond to a request made by the user of services substantially varies in dependence on whether or not the requested web content has been cached in the cache server.

If a cache server is newly added to a server-cluster system comprising cache servers each having such a characteristic, right after the cache server is newly added to the server-cluster system, a web content is not cached in the new cache server at all. Thus, every time a request for a web content is received from the user of services, the new cache server must acquire the web content from the web server. As a result, the time it takes to respond to the request made by the user of services is long. On the other hand, each existing cache server already operating in the server-cluster system so far has a number of web contents already cached therein. Thus, for such an existing cache server, the time it takes to respond to the request made by the user of services is short in comparison with the newly added cache server.

If the round-robin method described above is adopted to output as many requests to a newly added cache server as requests transmissible out to every already existing cache server having a big difference in power to process requests made by a user of services from the newly added cache server, the newly added cache server is not capable of completing the requests in time so that, in the newly added cache server, there is resulted in a long queue of requests each waiting for a processing turn. Thus, the time it takes to respond to a request made by the user of services becomes longer as exhibited by an exponential function in accordance with the logic of the queue. As a result, a long response-time delay is incurred, causing disadvantages to the user of services and hence betraying the trust of the user of services.

Addressing the problems described above, the present invention provides a distribution control method for preventing the time, which a new server added to a server-cluster system takes to process a request, from becoming long when the new server is added to the server-cluster system.

### SUMMARY OF THE INVENTION

The present invention provides a load distribution method adopted by a client-server system comprising a plurality of clients and a server cluster, which comprises a plurality of servers used for processing requests made by the clients and is used for dynamically changing the number of servers operating therein. The load distribution method is characterized in that the clients each monitor the number of servers composing the server cluster and, right after an increase in server count is detected as an increase caused by addition of a new server, the number of requests transmissible out to the newly added server is set at a value small in comparison with a value set for the number of requests transmissible out to every other server, and requests are output to the servers on the basis of the set values.

In the present invention, right after a new server is added to the server cluster, loads are distributed in a special way. That is to say, the number of requests transmissible out to a newly added server having a performance (or a processing power) lower than any already existing server is set at a value small in comparison with a value set for the number of requests transmissible out to every other already existing server. Thus, the time that the added server takes to process requests can be prevented from becoming long.

The client-server system provided by the present invention comprises clients and a server-cluster system, which comprises a plurality of servers used for processing requests made by the clients, wherein the number of servers composing the server-cluster system is increased or decreased in accordance with variations in request counts. Each of the clients has a load distribution function for distributing requests to the servers employed in the server-cluster system and a load control program for controlling a way in which requests are distributed. In addition, the load control program has a function for detecting a change in server count in the server-cluster system.

The present invention is characterized in that the load control program adjusts the number of requests to be output to a newly added server by setting the number of requests transmissible out to the added server at a value small in comparison with a value set for the number of requests transmissible out to every already existing server right after addition of the new server to the server-cluster system and, with the lapse of time, increasing the number of requests transmissible out to the added server step by step.

The load control program has a function for detecting a change in server count in the server-cluster system. Typically, the server-cluster system is provided with a management server for managing the number of servers composing the server-cluster system. If the number of servers is changed, the management server reports the change in server count to the load control program. The reporting of the change is used as a trigger of the load control program to start an operation to output requests to the added server.

The load control program increases the number of requests transmissible out to the added server step by step. There are 2 methods for computing an increment for the number of requests. In accordance with one of the methods, information on performance is obtained from the added server to be used in the computation of the increment. In accordance with the other method, on the other hand, no information is acquired from the added server.

In order to use performance information obtained from the server-cluster system in the computation of the increment for the number of requests to be transmitted out to the added server, the load control program is provided with a function to acquire performance information and a function to compute the increment on the basis of the information on performance. The information on performance includes a cache hit rate and the length of a queue of requests each waiting for a processing turn from the added server. Then, the load control program increases the number of requests on the basis of the computed increment.

If no performance information obtained from the added server is used in the computation of the increment for the number of requests to be transmitted out to the added server, on the other hand, the load control program increases the number of requests in accordance with a rule set in advance. For example, the load control program increases the number of requests by 10% per 10 seconds during a predetermined period of time lapsing since the addition of the added server to the server-cluster system.

As described above, the present invention provides a load distribution method adopted by a client-server system comprising a plurality of clients and a server cluster, which comprises a plurality of servers used for processing requests made by the clients and is used for dynamically changing the number of servers operating therein. The load distribution method is characterized in that the clients each monitor the number of servers composing the server cluster and, right after an increase in server count is detected as an increase caused by addition of a new server, the number of requests transmissible out to the newly added server is set at a value small in comparison with a value set for the number of requests transmissible out to every other server, and requests are output to the servers on the basis of the set values. Thus, the time that the newly added server takes to process requests can be prevented from becoming long when the new server is added to the server-cluster system.

### BRIEF DESCRIPTION OF THE DRAWINGS

FIG. 1 is a block diagram showing a rough configuration of a client-server system implemented by a first embodiment of the present invention;

FIG. 2 is a block diagram showing the structure and processing flow of a load control program 400 provided by the first embodiment of the present invention;

FIG. 3 shows a graph representing a typical load control function 411 provided by the first embodiment of the present invention;

FIG. 4 shows a graph representing another typical load control function 411 provided by the first embodiment of the present invention;

FIG. 5 shows a flowchart representing processing carried out by a server-count detection function 401 provided by the first embodiment of the present invention;

FIG. 6 shows a flowchart representing processing carried out by a performance detection function 402 provided by the first embodiment of the present invention;

FIG. 7 shows a flowchart representing processing carried out by a load-weight computation function 404 provided by the first embodiment of the present invention;

FIG. 8 is a block diagram showing a typical implementation of a connection pool;

FIG. 9 is a block diagram showing the data structure and data process of a load distribution function 300 provided by the first embodiment of the present invention;

FIG. 10 shows a flowchart representing processing carried out by the load distribution function 300 provided by the first embodiment of the present invention;

FIG. 11 is a block diagram showing the configuration of a storage system implemented by a second embodiment of the present invention;

FIG. 12 is an explanatory diagram showing a model of a method for changing the contents of a file assignment management table 2001;

FIG. 13 is a block diagram showing a rough configuration of a client-server system implemented by a third embodiment of the present invention; and

FIG. 14 is a block diagram showing the structure and processing flow of a load control program 400 provided by a fourth embodiment of the present invention.

### DETAILED DESCRIPTION OF THE PREFERRED EMBODIMENTS

Preferred embodiments of the present invention are described by referring to the diagrams as follows.

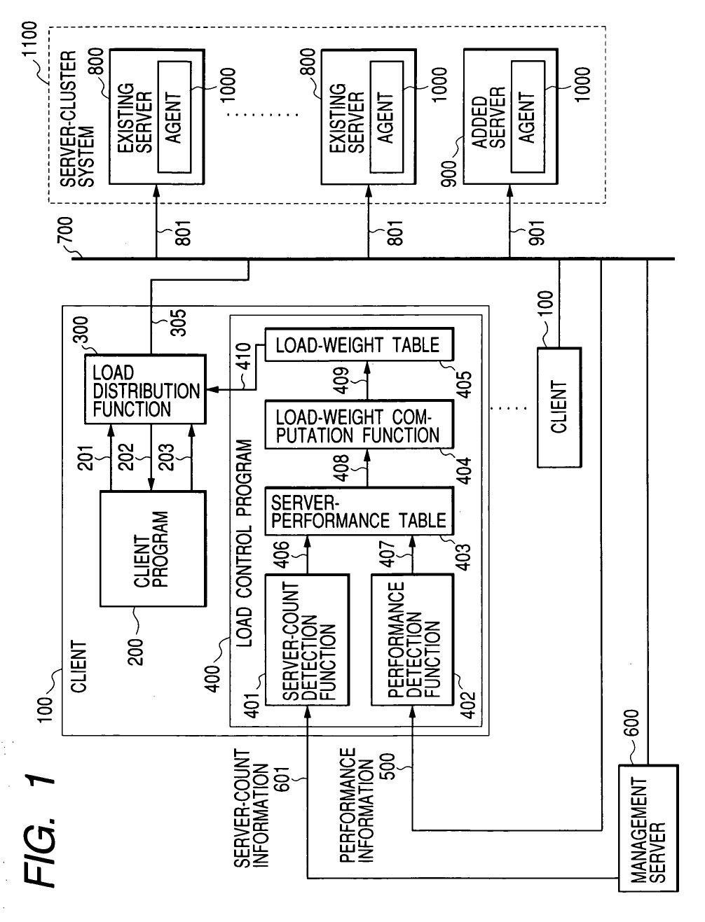

FIG. 1 is a block diagram showing a rough configuration of a client-server system implemented by a first embodiment of the present invention. The client-server system implemented by this embodiment comprises a plurality of clients 100 and a server-cluster system 1100 connected to the clients 100 by an inter-server network 700. A client 100 transmits a request to the server-cluster system 1100 as a request for a service, and receives a result of the request from the server-cluster system 1100. In the client 100, a load distribution program 300 and a load control program 400 are executed. It is to be noted that a request made by the client 100 and transmitted to the server-cluster system 1100 as a request for processing of a service is also referred to hereafter as an output request.

The load control program 400 creates a load-weight table 405, which contains data used by the client 100 to determine the number of requests to be assigned and transmitted out to each of the servers composing the server-cluster system 1100. The load distribution function 300 controls the amount of communication between each of the servers and a client program 200 in accordance with the load-weight table 405 created by the load control program 400. That is to say, the load distribution function 300 apportions output requests to the servers composing the server-cluster system 1100 and transmits the apportioned requests to the servers.

As described above, a load-setting unit is thus formed as a unit for apportioning output requests to the servers on the basis of the load-weight table 405 created by the load control program 400.

The server-cluster system 1100 comprises a plurality of servers connected loosely to each other by a network so that the server-cluster system 1100 appears to the clients 100 as a single-server system.

A cluster reconfiguration technology is applied to the server-cluster system 1100 to allow the number of servers composing the server-cluster system 1100 to be changed without terminating operations to render services. The cluster reconfiguration technology allows a new server to be added to the server-cluster system 1100 or a server already operating in the server-cluster system 1100 to be removed from the server-cluster system 1100. It is to be noted that a new server added to the server-cluster system 1100 is also referred to hereafter as a newly added server 900 whereas a server already operating in the server-cluster system 1100 is also referred to hereafter as an already existing server 800.

The client 100 and the server-cluster system 1100 are connected to a management server 600 for acquiring and managing information on the servers composing the server-cluster system 1100 and information on a configuration of services.

The management server 600 and agent programs 1000 implement the cluster reconfiguration technology in the server-cluster system 1100. To put it concretely, the agent program 1000 is executed in each of the servers composing the server-cluster system 1100. While communicating with each other, the management server 600 and the agent programs 1000 manage the configuration of the server-cluster system 1100. The agent programs 1000 measure loads of the servers composing the server-cluster system 1100 and report a result of the measurement to the management server 600 periodically. The management server 600 analyzes load information based on collected reports received from the agent programs 1000 and makes decisions to add a new server 900 to the server-cluster system 1100 and detach an already existing server 800 from the server-cluster system 1100.

It is to be noted that, instead of employing the management server 600, the function of the management server 600 can also be incorporated in the server-cluster system 1100 or each of the clients 100.

In the first embodiment provided by the present invention, the number of requests transmissible out to a server 900 newly added to the server-cluster system 1100 is suppressed to a value small in comparison with the number of requests transmissible out to each of the already existing servers 800 right after the addition of the newly added server 900 to the server-cluster system 1100. Thereafter, the number of requests transmissible out to the newly added server 900 is increased step by step. This is because, right after the addition of the newly added server 900 to the server-cluster system 1100, no sufficiently large number of data has been stored in a cache memory employed in the newly added server 900 so that the processing power of the newly added server 900 is low in comparison with the already existing servers 800. Thus, if about as many requests as those transmitted out to each of the already existing servers 800 are transmitted out to the newly added server 900, it is quite within the bounds of possibility that a long queue of requests each waiting for a processing turn unavoidably results in the newly added server 900. For this reason, right after the addition of the newly added server 900 to the server-cluster system 1100, control is executed to suppress the number of requests transmissible out from each client 100 to the newly added server 900 to a value small in comparison with the number of requests transmissible out to each of the already existing servers 800. Thereafter, as time goes by, a sufficiently large number of web contents is stored in the cache memory employed in the newly added server 900 so that the newly added server 900 is capable of carrying processing at the same power as each of the already existing servers 800.

The control described above can be executed by properly defining a load control function 411 for computing the value of a weight assigned to the newly added server 900. To be more specific, the load control function 411 is defined so that a small weight is assigned to the newly added server 900 right after the addition of the newly added server 900 to the server-cluster system 1100. Thereafter, the weight is increased step by step with the lapse of time.

As a typical implementation of the embodiment providing the client-server system of the present invention, a 3-layer web system is explained. The 3-layer web system is a system in which web servers, application (AP) servers and database (DB) servers each form a layer functioning as a server-cluster system, and these server-cluster systems form layers of a hierarchical structure in an order of web servers to DB servers by way of AP servers. In the 3-layer web system, a request made by a user of services is processed in accordance with the hierarchical structure in the order of a web server to a DB server by way of an AP server. In the 3-layer web system, the relation between a web server and an AP server as well as the relation between an AP server and a DB server are each a relation between a client and a server as is the case with the relation between a computer used by a user of services and a web server. To put it concretely, in the relation between a web server and an AP server, the web server is a client whereas the AP server is the server. Similarly, in the relation between an AP server and a DB server, the AP server is a client whereas the DB server is the server.

In the relation between a web server and an AP server, the web server and the AP server function as the client 100 and the server-cluster system 1100 respectively, whereas Apache and Tomcat are used as a web-server program and an AP-server program respectively. In this case, the load distribution function 300 is a load distribution module embedded in Apache as a load distribution module of Tomcat.

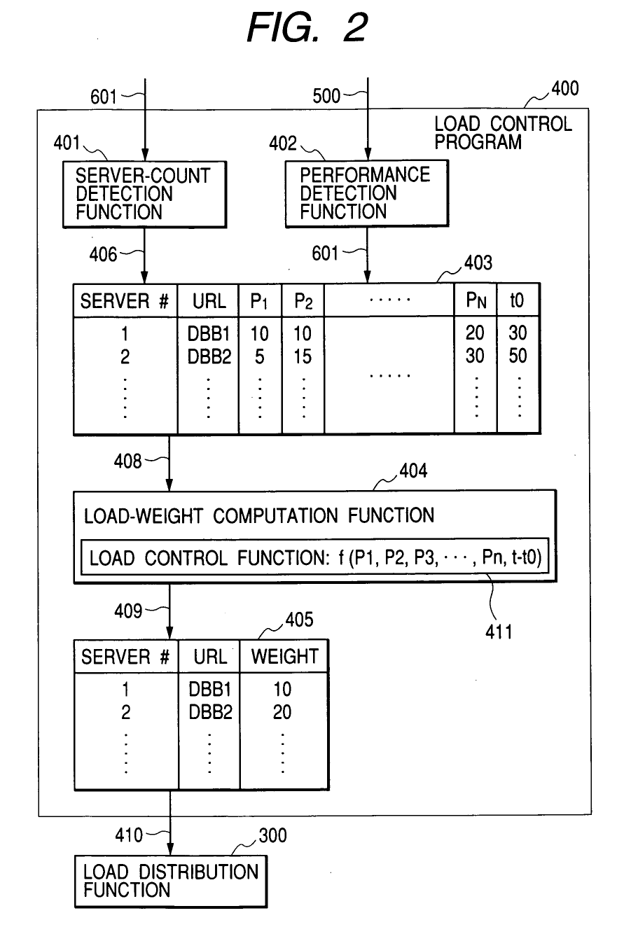

Next, details of the load control program 400 are explained. FIG. 2 is a block diagram showing the structure and processing flow of the load control program 400.

The load control program 400 has 2 pieces of data as respectively two tables, i.e., a server-performance table 403 and the load-weight table 405 cited earlier, each. The load control program 400 also has a server-count detection function 401 and a performance detection function 402 as functions for creating the server-performance table 403. In addition, the load control program 400 also has a load-weight computation function 404 as a function for creating the load-weight table 405 from the server-performance table 403.

As is obvious from the above description, reference numeral 403 denotes a typical server-performance table. The server-performance table 403 includes an entry for each of the servers composing the server-cluster system 1100. An entry provided for a server includes a server number (server #), a URL (Universal Resource Locator), a plurality of parameters P1 to PN and an addition time t0. The server number is a number assigned to the server to be used as an entry management number in the server-performance table 403. The URL is address information used to make an access to the server. The parameters represent the performance of the server. The addition time is a time at which the server was newly added to the server-cluster system 1100.

Typical parameters representing the performance of a server are classified into 2 types of parameters, i.e., static parameters and dynamic parameters. The static parameters are parameters that do not change during a system operation. The static parameters include the number of processors employed in the server, the operating frequency of the processors and the capacity of main memories. On the other hand, the dynamic parameters are parameters that change during a system operation. The dynamic parameters include a cache hit rate in the server and the length of a queue of requests each waiting for a processing turn in the server.

Also as is obvious from the above description, reference numeral 405 denotes a typical load-weight table. Much like the server-performance table 403, the load-weight table 405 includes an entry for each of the servers composing the server-cluster system 1100. An entry provided for a server includes a server number (server #), a URL and a weight. The server number is a number assigned to the server to be used as an entry management number in the load-weight table 405. The URL is address information used to make an access to the server. The weight is a figure of merit for the performance of the server.

The server-count detection function 401 and the performance detection function 402 play a role of creating an entry of the server-performance table 403 and cataloging the entry into the server-performance table 403. To be more specific, the server-count detection function 401 creates a new entry of the server-performance table 403 and records static parameters of the server in the entry. On the other hand, the performance detection function 402 acquires dynamic parameters of the server and records the dynamic parameters in the entry.

A load-weight computation function 404 is executed with a predetermined timing and updates the contents of the load-weight table 405 by using the server-performance table 403 as a base. To put it concretely, the load-weight computation function 404 is executed periodically at predetermined intervals to read out performance parameters of each server from the server-performance table 403 and supply the fetched performance parameters to the load control function 411 by using a message 408. For each server, the load control function 411 computes a weight of a server from the fetched performance parameters of the server and records the computed weight into the load-weight table 405 by using a message 409.

It is to be noted that the load control function 411 can be set and prescribed with a high degree of freedom. As a matter of fact, the load control function 411 can be defined as a complex multi-dimensional function using dynamic parameters of the performance of a server as an input thereof. For example, the load control function 411 can be defined as a function typically setting the number of requests transmissible out to the server at a low value for a low cache hit rate of the server or setting the number of requests transmissible out to the server at a low value for a long queue of requests each waiting for a processing turn in the server. In addition, a plurality of load control functions 411 can also be set in advance, and one of the load control functions 411 can be selected for use in accordance with a condition.

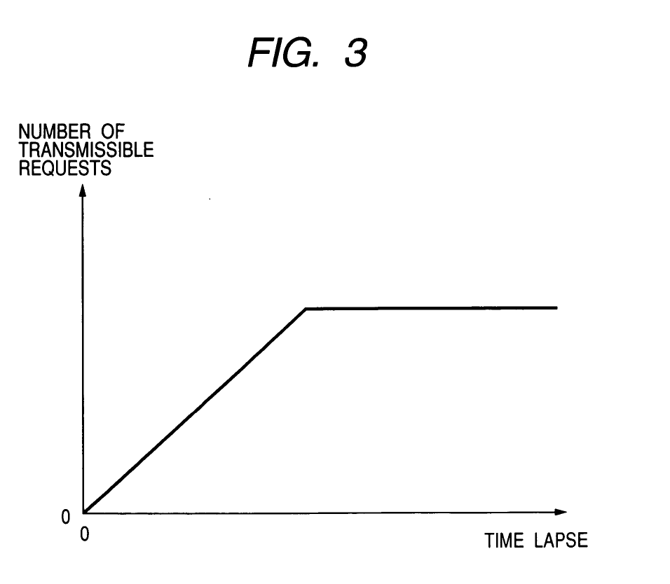

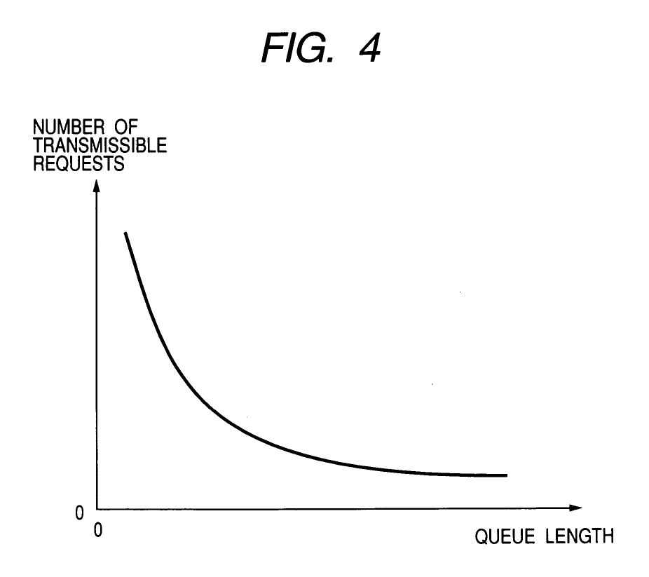

Typical load control functions 411 are shown in FIGS. 3 and 4. The typical load control function 411 shown in FIG. 3 is defined as a function using a period of time lapsing since the addition of a new server 900 to the server-cluster system 1100 as an input value. The period of time lapsing since the addition of a new server 900 to the server-cluster system 1100 is the parameter t0 included in the server-performance table 403 as the addition time. The load control function 411 increases the number of requests transmissible out to the newly added server 900 in proportion to the length of the time lapse since the addition of the newly added server 900 to the server-cluster system 1100 till a predetermined period of time lapses. After the predetermined period of time lapses, however, the load control function 411 sets the number of requests transmissible out to the new server 900 at a fixed value independent of the input value, which is the period of time lapsing since the addition of the newly added server 900 to the server-cluster system 1100.

On the other hand, the typical load control function 411 shown in FIG. 4 uses the length of a queue of requests each waiting for a processing turn in the newly added server 900 as an input value. In the case of the typical load control function 411 shown in FIG. 4, the number of requests transmissible out to the newly added server 900 is inversely proportional to the length of the queue of requests each waiting for a processing turn. That is to say, for a long queue, the number of requests transmissible out to the newly added server 900 is set at a low value. As the length of the queue decreases, however, the number of requests transmissible out to the newly added server 900 is increased.

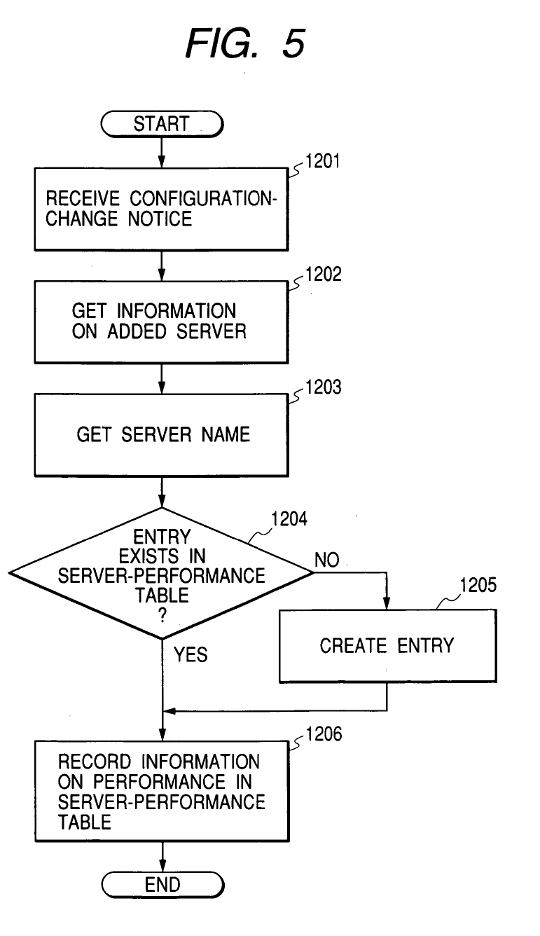

FIG. 5 shows a flowchart representing processing carried out by the server-count detection function 401 of the load control program 400. It is to be noted that the flowchart shown in FIG. 5 represents processing, which is carried out when a server is newly added to the server-cluster system 1100 as a newly added server 900.

First of all, the server-count detection function 401 is normally put in a standby state. When the client 100 receives a notice indicating that the configuration of the server-cluster system 1100 has been changed from the management server 600 at a step 1201 of the flowchart shown in FIG. 5, the flow of the processing goes onto a step 1202 at which the server-count detection function 401 fetches information on the newly added server 900 from the notice. For example, the notice indicates that the number of servers composing the server-cluster system 1100 has been changed.

Then, at the next step 1203, the server-count detection function 401 acquires a server name assigned to the newly added server 900 from the information on the newly added server 900. Subsequently, at the next step 1204, the server-count detection function 401 determines whether or not the entry of the newly added server 900 already exists in the server-performance table 403 by collating the acquired server name with the server-performance table 403. If the result of the determination indicates that the entry of the newly added server 900 does not exist in the server-performance table 403, the flow of the processing goes on to a step 1205 at which the server-count detection function 401 generates a new server number unique to the newly added server 900 and creates a new entry for the generated server number in the server-performance table 403. Then, the flow of the processing goes on to a step 1206. If the result of the determination indicates that the entry of the newly added server 900 already exists in the server-performance table 403, on the other hand, the flow of the processing goes on to the step 1206 without creation of a new entry.

At the step 1206, the server-count detection function 401 extracts the URL of the newly added server 900 and the static parameters of the newly added server 900 from the information on the newly added server 900, recording the URL and the static parameters in the entry for the server number in the server-performance table 403. Then, the server-count detection function 401 returns to the standby state.

In this way, a server-count detection unit is formed as a result of the processing carried out by the server-count detection function 401 to detect that the number of servers composing the server-cluster system 1100 has been changed.

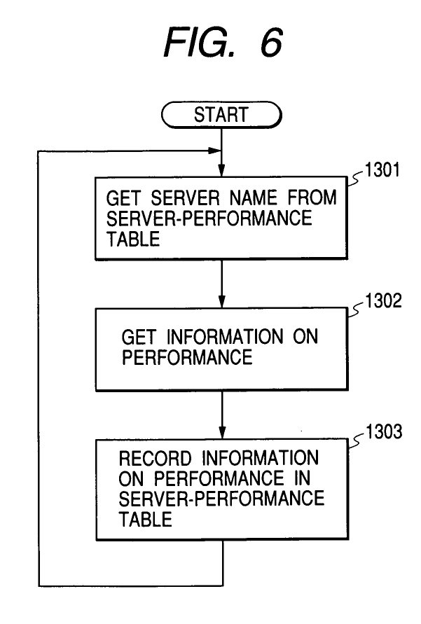

FIG. 6 shows a flowchart representing processing carried out by the performance detection function 402 of the load control program 400. The performance detection function 402 is executed with a predetermined timing to update the values of the dynamic parameters in each entry of the server-performance table 403. The flowchart begins with a step 1301 at which the performance detection function 402 searches entries of the server-performance table 403 for a server name recorded in the server-performance table 403. Then, at the next step 1302, the performance detection function 402 communicates with a server identified by the server name found from the server-performance table 403 in the search operation in order to acquire performance information related with the dynamic parameters. Subsequently, at the next step 1303, the performance detection function 402 records the acquired performance information in the server-performance table 403. The steps 1301 to 1303 are executed repeatedly as many times as entries of the server-performance table 403.

In this way, a state acquisition unit is formed as a result of the processing carried out by the performance detection function 402 to acquire the dynamic parameters representing each of the servers.

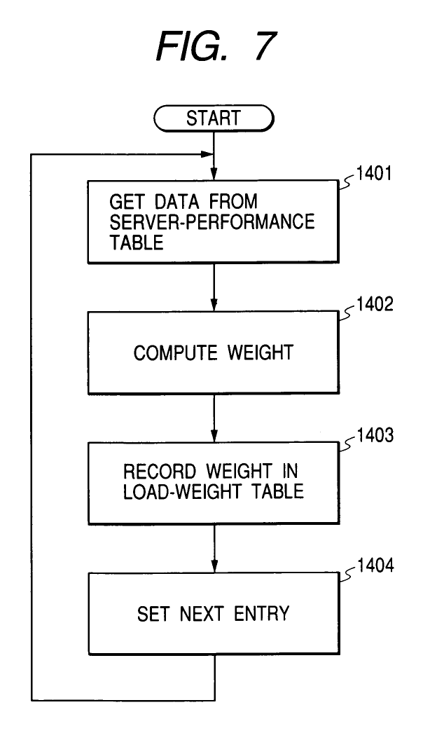

FIG. 7 shows a flowchart representing processing carried out by the load-weight computation function 404.

The load-weight computation function 404 is executed with a predetermined timing. That is to say, the load-weight computation function 404 is executed periodically, for example, at time intervals determined by a counting operation of a timer. The flowchart begins with a step 1401 at which the load-weight computation function 404 refers to the server-performance table 403 to acquire performance parameters of a server from an entry of the server-performance table 403. Then, at the next step 1402, the load-weight computation function 404 supplies the acquired performance parameters to the load control function 411 for computing a weight for the server as input values of the load control function 411. Subsequently, at the next step 1403, the load-weight computation function 404 records the computed weight in an entry provided in the load-weight table 405 for the server. Then, at the next step 1404, the load-weight computation function 404 increments the server number to identify the next entry in the server-performance table 403. In this way, the load-weight computation function 404 computes the weights of servers for all entries in the server-performance table 403 in an order of increasing server numbers.

It is to be noted that, instead of carrying out the processing of the load-weight computation function 404 in accordance with the flowchart shown in FIG. 7 periodically, the processing can also be performed with a timing triggered by an operation carried out by the server-count detection function 401 or the performance detection function 402 to update the entries of the server-performance table 403. For example, after the server-count detection function 401 updates the entries of the server-performance table 403, the server-count detection function 401 gives a notice to the load-weight computation function 404 to inform the load-weight computation function 404 that the entries of the server-performance table 403 have been updated. Then, the notice is used as a trigger of the load-weight computation function 404 to compute weights and update the load-weight table 405 in accordance with the flowchart shown in FIG. 7. Likewise, after the performance detection function 402 updates the entries of the server-performance table 403, the performance detection function 402 also gives a similar notice to the load-weight computation function 404, serving as a trigger of the load-weight computation function 404 to compute weights and update the load-weight table 405.

The following description explains processing carried out by the load distribution function 300 to distribute loads of servers in the server-cluster system 1100. First of all, a connection pool is described.

A connection pool is a means used in a technology of increasing a speed of communication between computers. In general, in order to carry out a communication between computers, it is necessary to establish a communication path referred to as a connection. It is to be noted that the established connection is eliminated when the communication is ended. Since it takes time to establish a connection, if processing to establish a connection is carried out every time a communication is performed, the efficiency of communication will be decreased. A connection pool is a means for storing (or pooling) the available connections, which were used before. These connections were once established but are not eliminated when their use is terminated, namely, when communications through the connections are ended. A pooled connection can thus be reused when a communication through the same communication path as the pooled connection is carried out again. Therefore, processing to reestablish the connection can be omitted. As a result, the efficiency of communication can be increased.

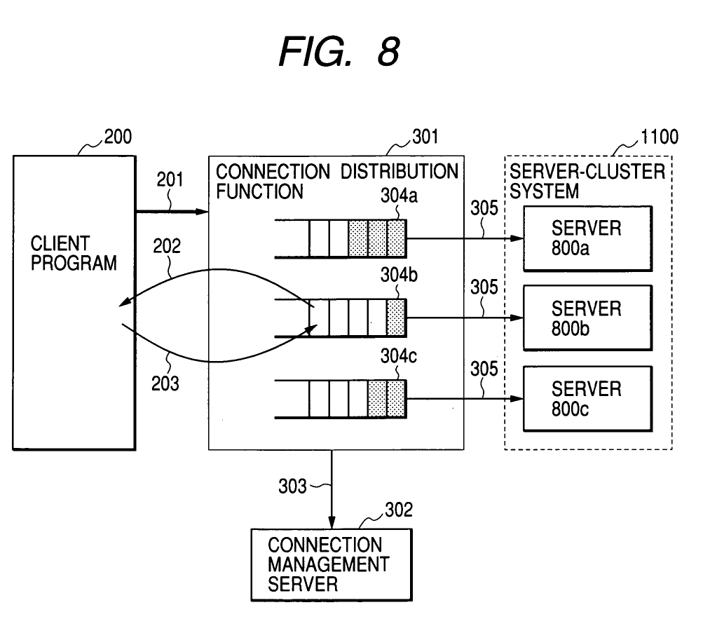

FIG. 8 is a block diagram showing a typical implementation of a connection pool to be used when the client program 200 transmits out a request to the server-cluster system 1100 comprising 3 servers 800a, 800b and 800c. A connection distribution function 301 is a function for creating a connection pool 304 for each server and managing the connection pools 304.

In the typical implementation shown in FIG. 8, a communication from the client 100 to the server 800a is carried out through 3 of 5 connections pooled in a connection pool 304a. The 3 connections are each represented by a darkened box in FIG. 8. Likewise, a communication from the client 100 to the server 800b is carried out through 1 of 5 connections pooled in a connection pool 304b. In the same way, a communication from the client 100 to the server 800c is carried out through 2 of 5 connections pooled in a connection pool 304c.

It is to be noted that, in the typical implementation shown in FIG. 8, the connection pools contain the same number of pooled connections for all the servers. It is also possible, however, to provide a configuration in which the number of connections that can be pooled varies from server to server.

The connection distribution function 301 records the number of pooled connections and the number of presently used connections in a connection management table 302 for each connection pool 304 by using a message 303.

In order for a client program 200 to transmit out a request to the server-cluster system 1100, it is necessary to acquire a required connection to be used in a communication to transmit out the request to the server-cluster system 1100 from a connection pool. In order to acquire the required connection, first of all, it is necessary to request the connection distribution function 301 to allocate the connection to the client program 200 by using a message 201. Requested by the client program 200, first of all, the connection distribution function 301 refers to the connection management table 302 by using a message 303 in order to determine a connection pool 304 from which a connection is to be acquired. In the typical implementation shown in FIG. 8, the connection pool 304b is determined as a pool from which a connection is to be acquired. Then, the connection distribution function 301 allocates the acquired connection to the client program 200 and informs the client program 200 that the connection has been allocated to the client program 200 by using a message 202. The client program 200 then communicates with the server 800b through the allocated connection.

When the communication is ended, the client program 200 transmits a message 203 to the connection distribution function 301 to notify the connection distribution function 301 that the use of the connection has been finished, and returns the connection to the connection distribution function 301. The connection distribution function 301 receives the connection and updates the connection management table 302 by changing the status of the connection from ‘being used’ to ‘available’.

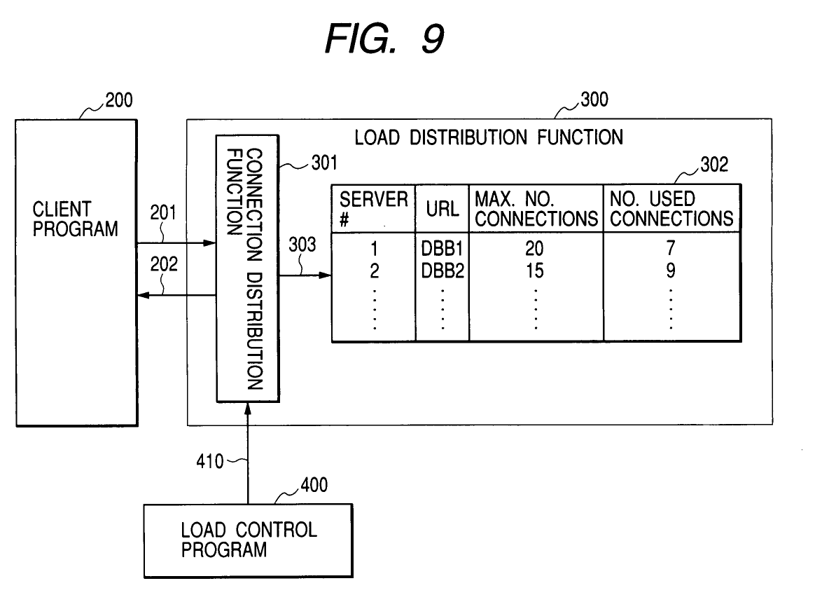

FIG. 9 is a block diagram showing the data structure and data process of the load distribution function 300 using connection pools explained above.

The load distribution function 300 is a function for distributing loads borne by a client program 200 to servers composing the server-cluster system 1100. The load distribution function 300 includes the connection distribution function 301 and the connection management table 302, which are described above.

As described earlier, in order for the client program 200 to transmit out a request to the server-cluster system 1100, it is necessary to acquire a required connection to be used in a communication to transmit out the request to the server-cluster system 1100 from a connection pool and, in order to acquire the required connection, it is necessary to request the connection distribution function 301 to allocate the connection to the client program 200 by using a message 201. Requested by the client program 200, the connection distribution function 301 refers to the connection management table 302 by using a message 303 in order to determine a connection pool 304 from which a connection is to be acquired.

As shown in FIG. 9, the connection management table 302 is a table of entries each provided for a server. The entries each include a server number (server #), a URL, a maximum connection count and a used-connection count. The URL is address information used in making an access to the server. The maximum connection count is the maximum number of connections that can be pooled for the server. The used-connection count is the number of connections presently being used.

The connection distribution function 301 refers to the connection management table 302 in order to determine a connection is to be allocated to the client program 200 and records the allocation of the connection in the connection management table 302 to reflect the reuse of the connection in the connection management table 302. The client program 200 transmits out a request to the server-cluster system 1100 by using the allocated connection.

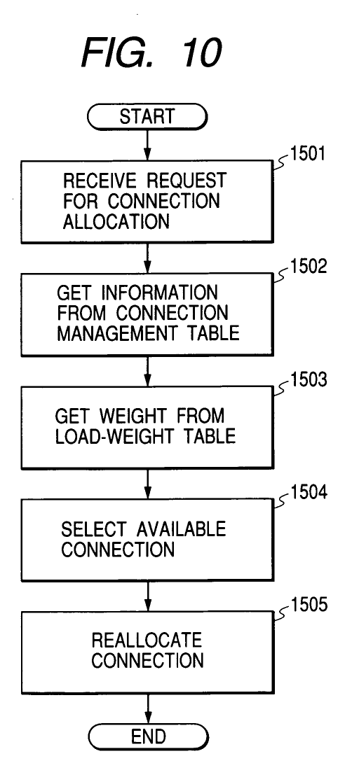

FIG. 10 shows a flowchart representing processing carried out by the load distribution function 300. At a step 1501, the load distribution function 300 receives a request for allocation of a connection from the client program 200. Then, at the next step 1502, the load distribution function 300 refers to the connection management table 302 to acquire information on the present state of allocation of connections. Subsequently, at the next step 1503, the load distribution function 300 refers to the load-weight table 405 to acquire the weight of each server. It is to be noted that the steps 1502 and 1503 can be executed in the reversed order.

Then, at the next step 1504, in accordance with a load distribution algorithm such as the weighted round-robin algorithm, the connection distribution function 301 selects a connection once established for a server on the basis of the information on the present state of allocation of connections and the weight of each server. Subsequently, at the next step 1505, the client program 200 is informed of the selected connection. In this way, the selected connection once established for a server is reallocated to the client program 200.

As described above, by using connection pools, a connection once established for a server can be determined as a connection to be reallocated to a client program 200 in accordance with loads borne by servers composing the server-cluster system 1100. The number of requests that can be transmitted out to a server is determined on the basis of the number of connections established for the server.

As explained so far, when a server 900 is newly added to the server-cluster system 1100, to which the client 100 transmits out a request, and hence changes the configuration of the server-cluster system 1100 in the client-server system implemented by the first embodiment of the present invention, the number of requests transmissible out to the newly added server 900 is initially set a value small in comparison with that set for each already existing server 800. In this way, it is possible to avoid generation of a long queue of requests each waiting for a processing turn in the newly added server 900 and increase the efficiency of processing in the entire server-cluster system 1100.

It is to be noted that, in the first embodiment, the dynamic parameters acquired by performance detection function 402 typically include the cache hit rate and the length of a queue of requests each waiting for a processing turn. However, the dynamic parameters may include pieces of other information as parameters used to control the number of requests to be transmitted to a server. To be more specific, the other pieces of information include information on the memory, information on the CPU, information on inputs and outputs and information on the network. The information on the memory includes the size of the used area of the memory. The information on the CPU includes the rate of utilization of the CPU. The information on inputs and outputs includes the number of inputs and outputs to and from a physical disk. The information on the network includes the amount of communication through the network.

In addition, in the first embodiment, the values of the dynamic parameters are supplied as they are to the load control function 411 as input values. Instead of supplying the values of the dynamic parameters as they are, however, changes in dynamic-parameter values can be supplied to the load control function 411 as input values. When the length of the queue of requests each waiting for a processing turn increases from 10 to 30, for example, the difference of 20 in place of the new length of 30 is supplied to the load control function 411 as an input value. By supplying a change in dynamic-parameter value, control can be executed to reduce the weight assigned to the server in case the length of the request queue very abruptly increases in a short period of time. It is to be noted that, in order to find a change in dynamic-parameter value, it is necessary to save a value acquired previously in the load-weight table 405 or another table.

Furthermore, in the first embodiment, the performance detection function 402 acquires performance information 500 of a server pertaining to the server-cluster system 1100 directly from the server. As another method to acquire the performance information 500, however, in place of the performance detection function 402, the management server 600 can also acquire the performance information 500 of a server pertaining to the server-cluster system 1100 from the server and then gather up the performance information 500 before supplying it to the performance detection function 402.

Moreover, in the first embodiment, the load distribution function 300 and the load control program 400 are incorporated in each client 100. However, a load distribution apparatus can be provided separately as a means for collecting requests made by the clients 100 and then apportioning the collected requests to servers of the server-cluster system 1100.

Next, a second embodiment of the present invention is explained. The second embodiment is an embodiment applying the present invention to a storage system (comprising a plurality of storage apparatus). The storage system is also a client-server system, which comprises clients, a directory server-cluster system and the storage apparatus.

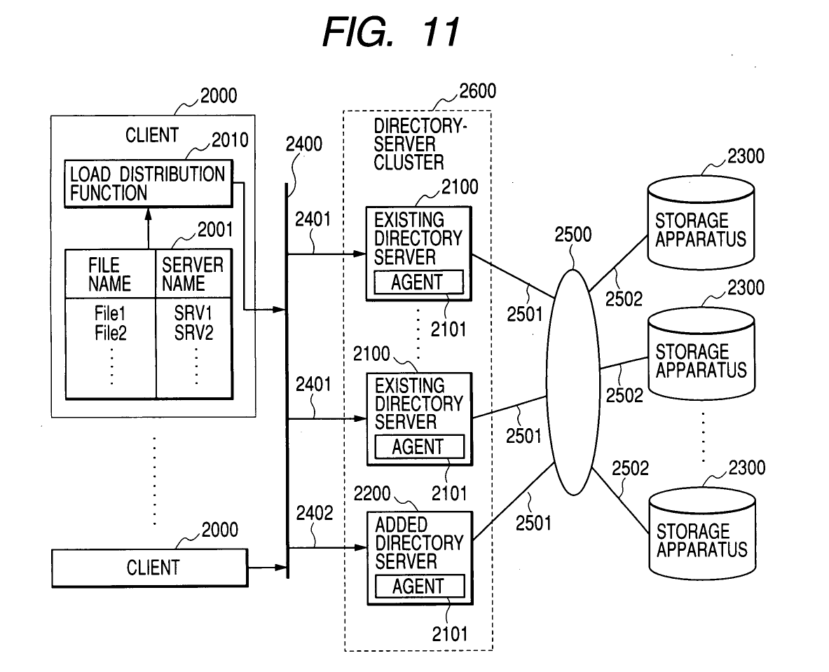

FIG. 11 is a block diagram showing the configuration of the storage system implemented by the second embodiment of the present invention. A directory-server-cluster system 2600 of the storage system implemented by the second embodiment renders file services to the clients 2000.

A client 2000 requests the directory-server-cluster system 2600 to render a file service to the client 2000. The directory-server-cluster system 2600 comprises a plurality of directory servers including already existing directory servers 2100 and newly added directory servers 2200, which are loosely connected to each other, appearing to the clients 2000 as a cluster system having only one directory server.

The substance of a file, that is, data contained in the file, is stored in a storage apparatus 2300. The directory-server-cluster system 2600 and the storage apparatus 2300 are connected to each other by using a SAN (Storage Area Network) 2500. The directory-server-cluster system 2600 and the SAN 2500 are connected to each other by using a network 2501. On the other hand, the storage apparatus 2300 and the SAN 2500 are connected to each other by using a network 2502. The clients 2000 and the directory-server-cluster system 2600 are connected to each other by using an inter-server network 2400.

A general file system comprises directory information indicating storage locations of files and file substances also indicated by the directory information. The directory information and the file substances (or data contained in the files) are stored in the same storage apparatus.

In the case of the storage system implemented by this embodiment, on the other hand, the directory information is stored in the directory-server-cluster system 2600 while the file substances are stored in the storage apparatus 2300. For this reason, the directory information includes information indicating a storage apparatus allocated to the substance of a file and information indicating a storage location for storing the substance in the storage apparatus.

A plurality of directory servers, which include already existing directory servers 2100 and newly added directory servers 2200, forms a cluster configuration. The directory information is distributed among the already existing directory servers 2100, being stored in the already existing directory servers 2100. It is to be noted that a specified directory server 2100 for storing directory information for a file is also referred to hereafter as a designated directory server taking charge of the file. A file assignment management table 2001 in each client 2000 is a table associating files with designated directory servers assigned to the files. It is also worth noting that the management tables 2001 of all the clients 2000 have the same contents.

By providing each of the clients 2000 with a file assignment management table 2001 for associating each file with a designated directory server assigned to the file as described above, an association-holding unit is formed.

The following description explains a procedure of processing carried out by this storage system to process a request made by a client 2000 as a request for acquisition of a file.

By using a message 2401, the client 2000 transmits a request for acquisition of a file to the directory-server-cluster system 2600 of the storage system. In order for the client 2000 to acquire a file, first of all, it is necessary to identify the designated directory server of the desired file. The client 2000 identifies the designated directory server of the desired file by referring to the file assignment management table 2001 included in the client 2000 as a table associating each file with a designated directory servers assigned to the file. Then, the client 2000 transmits a request for acquisition of a file to the identified designated directory server.

When receiving the request for acquisition of a file from the client 2000, the directory server 2100 identifies a storage apparatus 2300 for storing the file by referring to the directory information. Then, the directory server 2100 makes a request for the file, which is stored in the identified storage apparatus 2300. Receiving the request for the file, the storage apparatus 2300 transmits the file to the directory server 2100, which finally transmits the file to the client 2000 making the request.

A cache employed in each directory server 2100 is explained as follows.

In general, a directory server has a cache such as a cache memory. The directory server 2100 stores a file, which has been once received from a storage apparatus 2300, in a cache area of its memory. Thereafter, in response to a request made by a client 2000 as a request for acquisition of the file already stored in the cache, the directory server 2100 transmits the file to the client 2000, omitting a process to acquire the file from the storage apparatus 2300. In this way, the efficiency of the processing to acquire the file from the directory server 2100 can be increased.

The following description explains a case in which the number of directory servers composing the directory-server-cluster system 2600 is dynamically changed as is the case with the first embodiment.

When a new directory server 2200 is added to the directory-server-cluster system 2600, the function of an already existing directory server 2100 to take charge of some files stored in a storage apparatus 2300 is transferred to the newly added directory server 2200. That is to say, the designated directory server taking charge of the files migrates from the already existing directory server 2100 to the newly added directory server 2200.

If the designated directory server taking charge of some files stored in a storage apparatus 2300 migrates from a directory server to another, the contents of the file assignment management table 2001 of each client 2000 must also be changed as well. To put it concretely, assume for example that the designated directory server taking charge of file File1 migrates from directory server SRV1 to directory server SRV2. In this case, the contents of the file assignment management table 2001 of each client 2000 must also be changed as well. The contents of the file assignment management table 2001 can be changed by providing a management server in the same way as the first embodiment as a server for informing each client 2000 that the contents of the file assignment management table 2001 need to be changed, or by having the directory server 2100 directly request each client 2000 that the contents be changed.

The following description explains the state of a cache employed in a new directory server 2200 added to the directory-server-cluster system 2600. At a point of time the designated directory server taking charge of some files migrates from an already existing directory server 2100 to the newly added directory server 2200 after adding the new directory server 2200 to the directory-server-cluster system 2600, files are not stored at all in the cache employed in the newly added directory server 2200. Thus, if a client 2000 issues a request to the directory-server-cluster system 2600 as a request for acquisition of a file, the designated directory server taking charge of which has been changed from the already existing directory server 2100 to the newly added directory server 2200, the desired file must be once acquired from a storage apparatus 2300. Therefore, the cache employed in the newly added directory server 2200 is not used effectively. As a result, it takes long time to give a response to the request for acquisition of the file.

Accordingly, if the designated directory server taking charge of a large number of files migrates from an already existing directory server 2100 to the newly added directory server 2200, processing in the newly added directory server 2200 becomes stagnant. As a result, as a whole, the response characteristic of the directory-server-cluster system 2600 to give responses to the clients 2000 deteriorate. In order to prevent the performance of the storage system from deteriorating in this way, the designated directory server taking charge of a large number of files is not changed from an already existing directory server 2100 to the newly added directory server 2200 for the files at once, but must be changed gradually a number of times with only few files affected by the change at one time.

The following description explains a method of transferring the function of an already existing directory server 2100 to take charge of some files stored in a storage apparatus 2300 to the newly added directory server 2200. The transfer of such a function can be implemented by applying a hash function to a change to be made to the contents of the file assignment management table 2001 of each client 2000 in the same way as a load balancer designed by Foundry Networks Corporation.

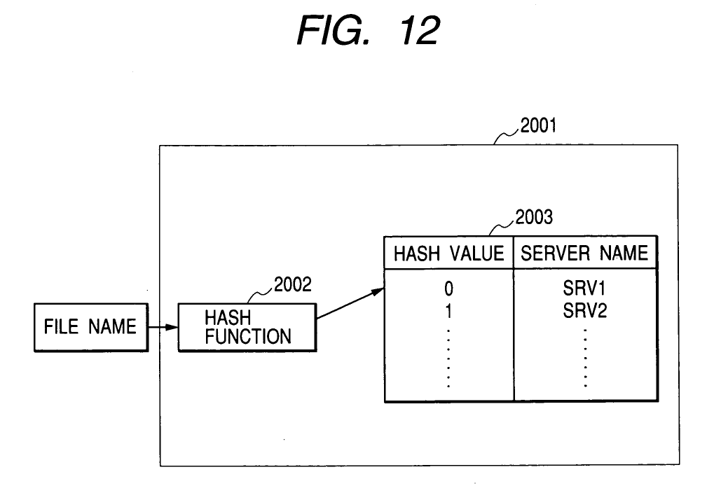

FIG. 12 is an explanatory diagram showing a model representing a method for changing the contents of the file assignment management table 2001 as a method of transferring a function to take charge of files gradually. The file assignment management table 2001 comprises a hash function 2002 and a server-name conversion table 2003.

When a client 2000 transmits a request for acquisition of a file to the directory-server-cluster system 2600, first of all, the name of the file is supplied to the hash function 2002, which then converts the file name into a hash value. It is to be noted that the hash function 2002 is set so that the maximum of hash values each obtained as a result of conversion is sufficiently greater than the total number of servers employed in the directory-server-cluster system 2600. Then, the server-name conversion table 2003 is searched for a server name associated with the hash value. The server name associated with the hash value identifies the designated directory server taking charge of the file.

In this case, the number of files, which the newly added directory server 2200 serves as a new designated directory server to take charge of, is increased gradually by carrying out an operation to gradually change the contents of the file assignment management table 2001. To put it concretely, assume for example a case in which the designated directory server taking charge of file File1, of which an already existing directory server 2100 has been taking charge so far, migrates to the newly added directory server 2200. In this case, the name of the already existing directory server 2100 recorded in an entry of the server-name conversion table 2003 as a server name associated with the hash value of file File1 is changed to the name of the newly added directory server 2200. This operation to change a server name is not carried out once for a plurality of hash values, but is carried out gradually a number of times with only for fewer hash values involved at one time.

The method for increasing the number of files, the designated directory server taking charge of which has migrated from an already existing directory server 2100 to the newly added directory server 2200, can be executed in the same way as the first embodiment. To put it concretely, a program operating in the same way as the load control program 400 shown in FIG. 1 is running in each client 2000 to execute the load control function 411 for computing the number of files, which the newly added directory server 2200 serves as a new designated directory server to take charge of, so that the number of such files can be increased gradually.

As explained so far, when a new directory server 2200 is added to the directory-server-cluster system 2600 handling each request made by a client 2000 as a request for acquisition of a file and, hence, changes the configuration of the directory-server-cluster system 2600 in the storage system implemented by the second embodiment of the present invention, the number of files stored in a storage apparatus 2300 as files, of which the newly added directory server 2200 serves as a new designated directory server taking charge, is set at a value small in comparison with that set for each other already existing directory server 2100. By setting the number of such files at a small value, the processing carried out by the newly added directory server 2200 can be prevented from becoming stagnant and the processing efficiency of the directory-server-cluster system 2600 as a whole can thus be increased.

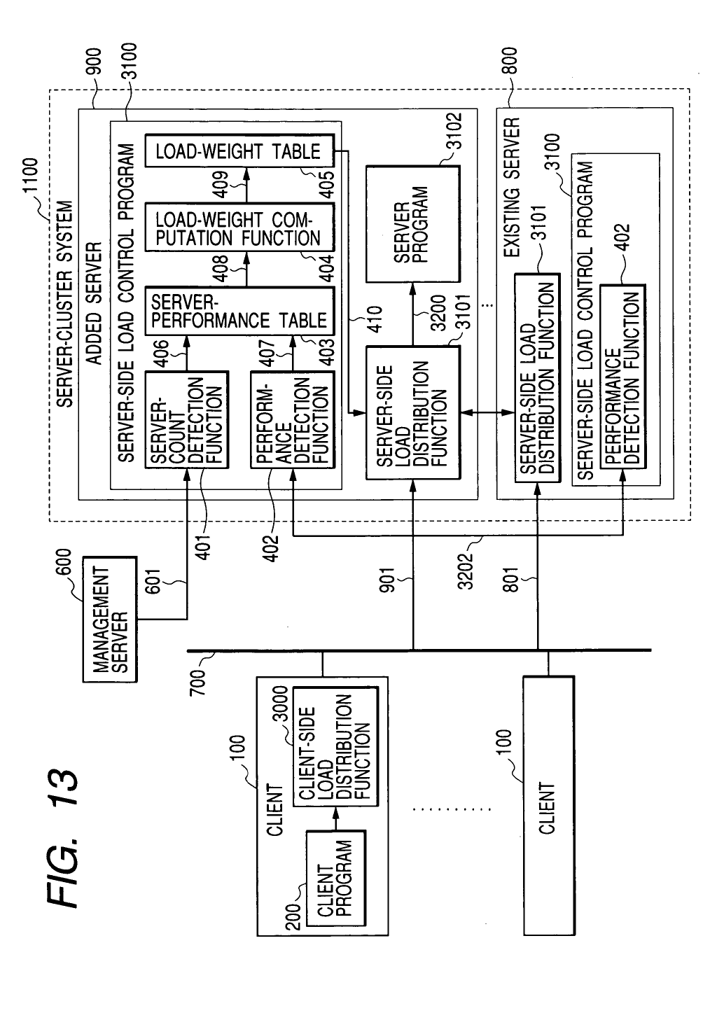

In the first and second embodiments described so far, the client 100 and the client 2000 respectively control the number of requests. In the case of a third embodiment described below, on the other hand, the server controls the number of requests. When a newly added server 900 receives an excessively large number of requests exceeding the processing power of the newly added server 900 from clients 100, the newly added server 900 transfers unprocessed requests on the queue to an already existing server 800 in order to reduce the load being borne by the newly added server 900. Details are explained by referring to FIG. 13.

In the case of the first embodiment shown in FIG. 1, the load distribution function of each client controls the number of requests transmitted to servers. In the third embodiment implemented by the third embodiment as shown in FIG. 13, on the other hand, each server controls the number of requests.

First of all, each element in the configuration of the third embodiment is explained. In each client 100, a client program 200 and a client-side load distribution function 3000 are executed. The client program 200 is a program for receiving a request for processing from a client user. A request received by the client program 200 is then passed on to the client-side load distribution function 3000. The client-side load distribution function 3000 selects one of servers included in the server-cluster system 1100, and transmits the request to the selected server by using a message 801 or 901. In the case of the first embodiment explained earlier by referring to FIG. 1, the client-side load distribution function 3000 of each client selects a server by making an effort to reduce the number of requests transmitted out to a newly added server. In the case of the third embodiment, on the other hand, in place of the client-side load distribution function 3000 of each client, a server-side load distribution function 3101 of each server controls the number of requests handled by the server.

After a newly added server 900 or an already existing server 800 receives a request from a client 100 and processes the request, the server 900 or 800 returns a result of processing to the client 100. Each server executes a server program 3102, the server-side load distribution function 3101 and a server-side load control program 3100. The server program 3102 is a program for processing a request. The server-side load distribution function 3101 is a function for apportioning a request to the server program 3102. The server-side load control program 3100 is a program for providing the server-side load distribution function 3101 with information on a load of the server. The function of the server-side load control program 3100 is all but identical with the function of the load control program 400 provided by the first embodiment shown in FIG. 1. As described earlier, the load control program 400 creates a load-weight table 405 on the basis of information received from the server-count detection function 401 as information indicating the number of servers employed in the server-cluster system 1100 and information received from the performance detection function 402 as information on the performance of each server. The function of the server-side load control program 3100 is different from that of the load control program 400 in that the performance detection function 402 of the server-side load control program 3100 is used in a way different from the performance detection function 402 of the load control program 400. That is to say, the performance detection function 402 of the first embodiment shown in FIG. 1 is executed to collect information on the performance of every individual server from the individual server. On the other hand, the performance detection function 402 of the third embodiment the shown in FIG. 13 is executed to drive the servers employed in the server-cluster system 1100 to exchange information on performance with each other by using messages 3202.

The server-side load distribution function 3101 plays the role of determining a server to process an incoming request in accordance with the load-weight table 405 created by the server-side load control program 3100.

The following description explains a sequence of operations carried out by the server-side load control program 3100. First of all, the server-side load distribution function 3101 receives a request from a client 100. If the load of the server including the server-side load distribution function 3101 is light, the server-side load distribution function 3101 passes on the request received from the client 100 to the server program 3102 of the server including the server-side load distribution function 3101, and the server program 3102 then processes the request If the load of the server including the server-side load distribution function 3101 is heavy, on the other hand, the server-side load distribution function 3101 does not pass on the request received from the client 100 to the server program 3102 of the server including the server-side load distribution function 3101. Instead, the server-side load distribution function 3101 searches the load-weight table 405 for another server bearing a light load and, by using a message 3201, the server-side load distribution function 3101 transfers the request to the server-side load distribution function 3101 of the other server. As described before, a weight cataloged in the load-weight table 405 as the weight of the newly added server 900 is set at a value small in comparison with those of the already existing servers 800. Thus, there is no much chance of selecting the newly added server 900 as a server to which the request is to be transferred. It is therefore possible to implement the control of the number of requests to be processed by the newly added server 900 so as to prevent requests from being very abruptly concentrated on the newly added server 900 and, hence, prevent the time, which the newly added server 900 takes to respond to a request processed by the newly added server 900, from lengthening substantially.

Next, a fourth embodiment of the present invention is explained. In the case of all the embodiments described so far, the number of requests to be processed by a server is controlled for every server. In addition, triggered by addition of a server to the server-cluster system 1100, the control of the number of requests is started. In the case of the fourth embodiment to be described below, on the other hand, the number of requests to be processed by a server is controlled not for every server, but for every software application, which is referred to hereafter simply as an application. In addition, the control of the number of requests to be processed is started when triggered by addition of an application instead of addition of a server.

Assume a typical case in which a plurality of applications shares a server. In this case, the control of the number of requests to be processed is executed for each of the applications. The control of the number of requests for every application is explained by giving a simple example. Assume that the server-cluster system includes 3 servers, namely, servers A, B and C. Let Application 1 be running on servers A and B whereas application 2 be running on server C. Assume that the number of requests issued to application 2 very abruptly increases so that server C is no longer capable of processing the numerous requests by itself. In this case, in order to prevent the time application 2 takes to give a response to every request from lengthening, a work is carried out to add the number of servers, which can be used by application 2, so that application 2 can also be executed on server B. Thus, at this point of time, the number of servers used by application 2 is increased to 2 and, in addition, applications 1 and 2 share server B. In this case, right after application 2 is added to server B, the low processing performance of application 2 becomes a problem as the processing performance of a newly added server does right after the new server is added to the server-cluster system as described before. In order to solve this problem, it is necessary to set the number of requests transmissible out to application 2 running on server B at a value small in comparison with that set for the number of requests transmissible out to application 2 running on server C. For this reason, the load control program 400 of the embodiment shown in FIG. 1 needs to control loads for every application.

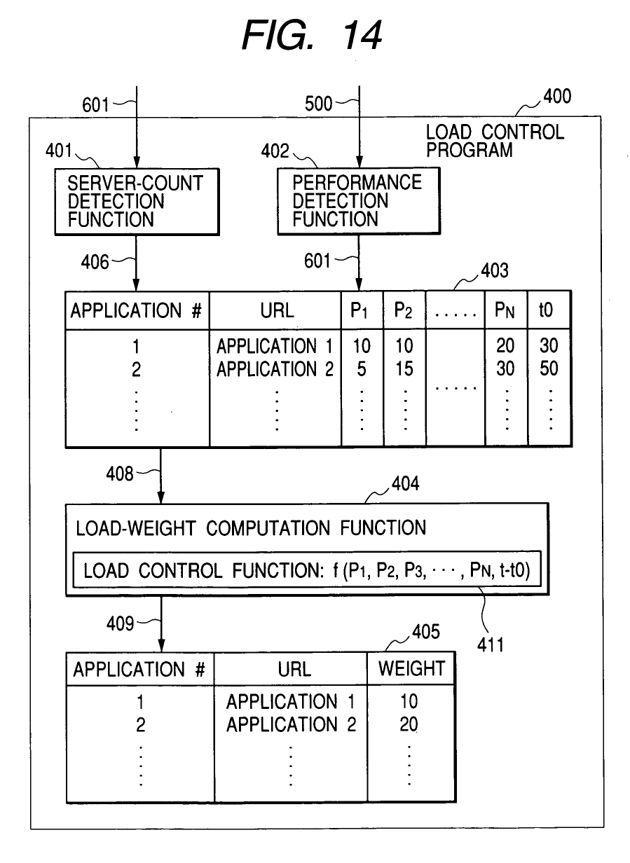

In order to implement the control of the number of requests for every application, the load control program 400 of the embodiment shown in FIG. 1 needs to manage performances not for every server, but for every application. That is to say, the entries provided in the server-performance table 403 and the load-weight table 405 for every server need to be changed to entries for every application as shown in FIG. 14. Then, the load distribution function 300 executes control to reduce the number of requests transmissible out to a newly added application by referring to the load-weight table 405 including entries each provided for an application.

1. A load distribution method adopted by a client-server system comprising a plurality of clients and a server cluster, which includes a plurality of servers each used for processing requests made by said clients and allows the number of said servers to be changed dynamically, wherein each of said clients:
detects the number of servers composing said server cluster;
right after detecting an increase in said number of servers, sets an allocation of requests transmissible out to a newly added server at a value small in comparison with that set for each of said other servers; and
transmits out requests to said servers on the basis of said set allocation.

2. A load distribution method according to claim 1, wherein each of said clients sets said allocation of requests transmissible out to said newly added server at a value increasing with the lapse of time.

3. A load distribution method according to claim 1, wherein said detection of an increase in said number of said servers is used as a trigger of each of said clients to set said allocation of requests transmissible out to said newly added server at a value small in comparison with that set for each of said other servers.

4. A load distribution method according to claim 1, wherein each of said clients:
acquires information on a performance of said newly added server; and
sets said allocation of requests transmissible out to said newly added server on the basis of said acquired information.

5. A load distribution method according to claim 1, wherein each of said clients:
acquires information on a state of said newly added server; and
sets said allocation of requests transmissible out to said newly added server on the basis of said acquired information.

6. A load distribution method according to claim 5, wherein said information on a state of said newly added server includes at least a cache hit rate, a cache utilization ratio or the number of requests each waiting for a processing turn.

7. A load distribution method according to claim 1 wherein:
said client-server system has a management server for managing the number of servers composing said server cluster; and
a notice received from said management server as a notice of an increase in said number of said servers is used as a trigger of each of said clients to set said allocation of requests transmissible out to said newly added server at a value small in comparison with that set for each of said other servers.

8. A load distribution method according to claim 1 wherein:
said client-server system has a management server for acquiring information on a performance of each of said servers; and
each of said clients:
acquires said information on a performance of each of said servers;
sets said allocation of requests transmissible out to said newly added server on the basis of said acquired information.

9. A load distribution method according to claim 1, wherein each of said clients sets said allocation of requests transmissible out to said newly added server by setting the number of connections for communications with said servers.

10. A load distribution method according to claim 1, wherein each of said clients sets an allocation of requests transmissible out to each of said servers by changing quotas each set for every individual one of said servers as an allotment of requests transmissible out to said individual server.

11. A load distribution method according to claim 10 wherein:
said client-server system has storage apparatus connected to said servers;
each of said servers holds directory information indicating storage locations of files stored in said storage apparatus; and
each of said clients sets said allocation of requests transmissible out to each of said servers by changing quotas each provided for every individual one of said servers as an allotment of said directory information stored in said individual server where said allotment of said directory information storable in said individual server represents an allotment of requests transmissible out to said individual server.

12. A client-server system comprising a plurality of clients and a server cluster, which includes a plurality of servers each used for processing requests made by said clients and allows the number of said servers to be changed dynamically, wherein:
each of said clients includes:
a load-setting unit for setting an allocation of requests transmissible out to each of said servers;
a server-count detection unit for detecting the number of servers composing said server cluster; and
a load distribution unit for transmitting out requests to each of said servers on the basis of allocations each set by said load-setting unit as said allocation of requests transmissible out to each of said servers; and
right after said server-count detection unit detects an increase in said number of servers, said load-setting unit sets an allocation of requests transmissible out to a newly added server at a value small in comparison with that set for each of said other servers.

13. A client-server system according to claim 12 wherein:
each of said clients has an allotment-holding unit for holding an allotment set for every individual one of said servers as an allotment of requests transmissible out to said individual server; and
said load-setting unit sets an allocation of requests transmissible out to each of said servers by changing quotas each set for every individual one of said servers as said allotment of requests transmissible out to said individual server.

14. A client-server system according to claim 13, said client-server system further comprising storage apparatus connected to said servers wherein:
each of said servers is provided with a directory-information-holding unit for holding directory information indicating storage locations of files stored in said storage apparatus;
said clients are provided with a management server for holding quotas each provided for every individual one of said servers as an allotment of said directory information storable in said individual server; and
said load-setting unit sets said allocation of requests transmissible out to each of said servers by changing said quotas each provided for every individual one of said servers as an allotment of said directory information stored in said individual server.

15. A load distribution method according to claim 2 wherein:
said client-server system has a management server for managing the number of servers composing said server cluster; and
a notice received from said management server as a notice of an increase in said number of said servers is used as a trigger of each of said clients to set said allocation of requests transmissible out to said newly added server at a value small in comparison with that set for each of said other servers.

16. A load distribution method according to claim 2, wherein each of said clients sets said allocation of requests transmissible out to said newly added server by setting the number of connections for communications with said servers.

17. A load distribution method according to claim 3, wherein each of said clients sets said allocation of requests transmissible out to said newly added server by setting the number of connections for communications with said servers.

18. A load distribution method according to claim 4, wherein each of said clients sets said allocation of requests transmissible out to said newly added server by setting the number of connections for communications with said servers.

19. A load distribution method according to claim 5, wherein each of said clients sets said allocation of requests transmissible out to said newly added server by setting the number of connections for communications with said servers.

20. A load distribution method according to claim 6, wherein each of said clients sets said allocation of requests transmissible out to said newly added server by setting the number of connections for communications with said servers.

21. A load distribution method according to claim 7, wherein each of said clients sets said allocation of requests transmissible out to said newly added server by setting the number of connections for communications with said servers.

22. A load distribution method according to claim 15, wherein each of said clients sets said allocation of requests transmissible out to said newly added server by setting the number of connections for communications with said servers.

23. A load distribution method according to claim 8, wherein each of said clients sets said allocation of requests transmissible out to said newly added server by setting the number of connections for communications with said servers.
